(19) United States
(12) Patent Application Publication
(10) Pub. No.: US 2021/0339682 A1
(43) Pub. Date: Nov. 4, 2021

(54) BICYCLE MOUNTING SYSTEM

(71) Applicant: Kevin PINNELL, Charlotte, NC (US)

(72) Inventor: Kevin PINNELL, Charlotte, NC (US)

(21) Appl. No.: 17/286,807

(22) PCT Filed: Oct. 17, 2019
(86) PCT No.: PCT/US2019/056711

§ 371 Date: Apr. 19, 2021

Related U.S. Application Data
(60) Provisional application No. 62/747,806, filed on Oct. 19, 2018.

(51) Int. Cl. B60R 9/10; B60R 9/06; B62H 3/12

(52) U.S. Cl. CPC B60R 9/10; B62H 3/12; B60R 9/06

(57) ABSTRACT

A bicycle mounting system for mounting a bicycle on a vehicle, wall, mechanics stand or other places a bicycle might me mounted. This bicycle mounting system is designed to operatively couple and support a bicycle from its frame, wheel or other parts of the bicycle.

### BACKGROUND OF THE INVENTION

Traditionally, bicycles have been used for transportation. With the rise in popularity of bicycling for recreation and sport, the need to transport bicycles on vehicles has created a consumer demand for bike carrying racks that mount to different types of vehicles. Similarly, this same rise in cycling has given rise to the need to store multiple bikes indoors and outdoors and has given rise to a number of bicycle storage racks and storage systems. In addition, environmental concerns have led many cities to encourage bicycles as a primary mode of transportation and this has led to the rise in demand for wall mounting bicycle racks and other storage solutions. The number of different bike designs and configurations has created a need for racks that have the flexibility to transport and store bicycles with different specifications and typically on the same rack.

The most common bicycle carrier configurations seen in the marketplace are designed to mount a bicycle to a trailer hitch on a vehicle or to mount the bicycle to the back of a vehicle using a support structure strapped to the vehicle or to mount the bicycle to the top of the car or flatbed of a pickup truck using a rail or channel system. Platform carriers are also employed to carry bicycles but are usually reserved for larger vehicles such as on the back of trucks, recreational vehicles or on the front of city busses.

Many of the racks used to carry bicycles on the back of vehicles are designed to support the bicycle from the top tube. The top tube is the frame member leading from the steerer tube to the seat tube. The top tube usually slopes but is still generally designed to be a horizontal member making it the most popular choice for supporting a bicycle on a rack. Top tube bicycle racks typically have a number of rearward pointing support members that the bicycles are hung from by their top tubes and are then clamped, strapped or otherwise secured to these horizontal support members. The disadvantages of these types of bicycle carriers is that they necessitate a large number of supporting members and stabilizing mechanisms and are therefore, large, heavy and cumbersome to install and use.

Bike racks that utilize rail systems to mount the bicycles to the top of the vehicle or in the bed of a truck typically secure the front fork to skewers after first removing the front wheel. These skewers typically are attached to the rail system in some arrangement that use quick release bolts or locking bolts to apply pressure to the fork's bolt grooves to keep the bike in place. Typically the back wheel is left on the bicycle as it is harder to remove and is positioned in a channel or on a rail secured with straps or locking mechanisms.

Channel bicycle racks have a long member that is configured as a channel and both wheels of the bicycle are placed in this channel and then a supporting member is used to either support the wheels in place or support one of the support tubes of the bicycle.

Platform bicycle racks typically utilize a platform that is coupled to the vehicles trailer hitch and provide a stable base for loading multiple bicycles for transport. City busses typically sport a bicycle platform on the front of the bus for carrying bicycles for passengers. The primary drawback of these arrangements is that they are typically the heaviest solution and hardest to install given the resulting weight involved in constructing such a platform.

Other solutions seen in the patent archives and marketplace include mounting bikes by their seat post, blow-up air bladders mounted to the back of vehicles as well as racks installed on the interior of buses and trains the allow the passenger to bring and store a bicycle in the interior of the vehicle and in some case by hanging the front tire from a hook or other similar device.

### SUMMARY OF THE INVENTION

The bicycle mounting system includes a bicycle mounting system assembly with a frame support platform that attaches and secures to the frame of the bike with a wheel support tube insert and a wheel support member that supports and secures the bicycle wheel.

The bicycle mounting system assembly mounts the bicycle securely on any structure including a vehicle bicycle rack, mechanics stand, a stationary storage rack or wall mounting system.

### BRIEF DESCRIPTION OF THE DRAWINGS

The invention, together with objects and advantages thereof, may be best understood by reference to the following description of the one or more embodiments of the present application together with the accompanying drawings in which:

FIG. 1 is a left side elevation view of the bicycle mounting system with a portion of the relevant bicycle frame and wheel illustrated.

FIG. 2 is a front perspective view of the bicycle mounting system with a portion of the relevant bicycle frame and wheel illustrated.

### DETAILED DESCRIPTION OF THE INVENTION

The illustrations of the drawings are for the purpose of describing one version of the invention and are not intended to limit the scope of the present invention.

The present invention is a bicycle mounting system that allows a bicycle to be secured a vehicle, wall, mechanics stand or other places a bicycle might me mounted when coupled with such apparatus.

The present invention allows a bicycle to be stabilized from a smaller platform stand by providing more stability from its three points of contact.

A bicycle is lowered onto the present invention and is secured by the bicycle support system as described.

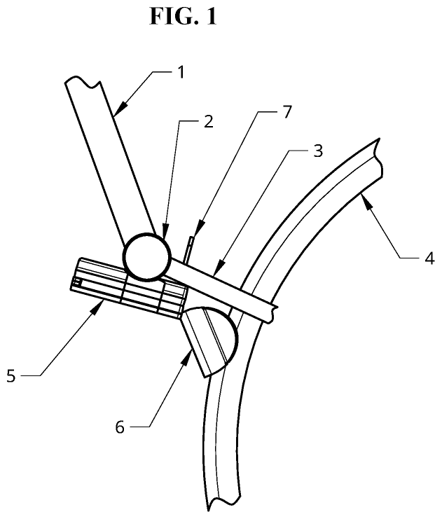

FIG. 1 illustrates the bicycle mounting system from a left side elevation view with a portion of the relevant bicycle frame and wheel illustrated.

The frame support member 5 is operatively coupled to the crank frame shell 2 of a bicycle frame.

The down tube of the bicycle 1 juts upward and ultimately terminates in the head tube that supports the handle bars—not pictured.

The wheel support tube insert 7 holds the bicycle frame securely on the frame support platform 5 and goes between the wheel support tubes 3.

The wheel support member 6 stabilizes the bicycle wheel 4.

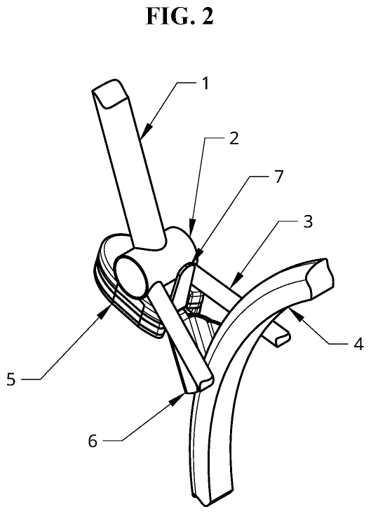

FIG. 2 illustrates the bicycle mounting system from front side perspective view with a portion of the relevant bicycle frame and wheel illustrated.

The frame support member 5 is operatively coupled to the crank frame shell 2 of a bicycle frame.

The down tube of the bicycle 1 juts upward and ultimately terminates in the head tube that supports the handle bars—not pictured.

The wheel support tube insert 7 holds the bicycle frame securely on the frame support platform 5 and goes between the wheel support tubes 3.

The wheel support member 6 stabilizes the bicycle wheel 4.

What is claimed:

1. A mounting apparatus comprising:
a receiving member comprising a receiving section configured to receive a bicycle frame; and
a support member configured to support the receiving member, wherein the support member supports the receiving in a manner not to obstruct the receiving section and
a wheel support member configured to support the bicycle wheel.

2. The mounting apparatus of claim 1, wherein the receiving section has a shape of a platform.

3. The mounting apparatus of claim 1, wherein the receiving section comprises a bottom and at least two opposing sides extending upward from the bottom.

4. The mounting apparatus of claim 3, wherein one of the at least two opposing sides has an insert or a retaining member at a top section of the one of the at least two opposing sides.

5. The mounting apparatus of claim 4, wherein the bottom section is configured to support a bicycle wheel.

6. The mounting apparatus of claim 1, wherein the support member has a cutout section at the top portion thereof that matches a shape of a bottom of the receiving member.

7. The mounting apparatus of claim 1, wherein the support member has the shape of a wheel support tube insert section at the top portion thereof that receives the shape of a bottom of the receiving member and wheel support members.

8. A bicycle rack for supporting a frame of a bicycle, the bicycle rack comprising:
a frame support member that supports the frame of the bicycle, wherein the frame support member has a shape to substantially match a shape of a bottom portion of the bicycle;
a vertical support member that is operatively coupled to at least a bottom portion of the bicycle frame, wherein the vertical support member has a insert shape at a top section thereof that receives at least the bottom portion of the bicycle frame between the chain support tubes; and
a wheel support member that supports the wheel assembly.
